(19) United States
(12) Patent Application Publication
(10) Pub. No.: US 2018/0072263 A1
(43) Pub. Date: Mar. 15, 2018

(54) VEHICLE-DISABLING REMOTE ANTI-THEFT SYSTEM AND METHOD

(71) Applicant: Patricia E. Green, Carson, CA (US)

(72) Inventor: Patricia E. Green, Carson, CA (US)

(21) Appl. No.: 15/705,233

(22) Filed: Sep. 14, 2017

Related U.S. Application Data
(60) Provisional application No. 62/394,670, filed on Sep. 14, 2016.

(51) Int. Cl. B60R 25/04; B60R 21/0136; B60R 25/102; B60R 25/104; B60R 25/23; B60R 25/30; B60R 25/33

(52) U.S. Cl. CPC B60R 25/04; B60R 21/0136; B60R 25/102; B60R 25/104; B60R 2021/0027; B60R 25/302; B60R 25/305; B60R 25/33; B60R 25/23

(57) ABSTRACT

A vehicle anti-theft system includes a vehicle control module having an electrical interface, a transceiver, and a GPS receiver, a kill switch, a mobile device with a microphone, a mobile device application, a programmable security passcode, a security camera, at least one impact detection sensor, and a speaker. The vehicle control module communicates with and controls the vehicle via the electrical interface. The transceiver allows the vehicle control module to communicate with the mobile device using a wireless signal, while the GPS receiver receives a signal from a global positioning system satellite in order to determine the vehicle's location at any given time. The kill switch is integrated into the vehicle in such a way that it communicates with the vehicle control module and may terminate power to the vehicle if so prompted by the vehicle control module.

### CROSS-REFERENCE TO RELATED APPLICATION(S)

The present application is related to and claims priority to U.S. Provisional Patent Application No. 62/394,670 filed Sep. 14, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of security of existing art and more specifically relates to anti-theft systems.

### RELATED ART

An anti-theft system is a device used to prevent or deter the unauthorized appropriation of valuable assets. Theft is a universal and long-lived crime. Anti-theft systems range from antiquated mechanical systems such as locks to modern, computerized alert systems. Methods of anti-theft vary considerable as well; these may include preventing the removal of items, alerting authorities or other individuals to theft, identifying thieves in order to improve the chance of arrest, using forensic markings, and others. Unfortunately, many of these methods are easily outmoded by thieves, especially as the use of modern technologies increase. Some methods may not be suitable for preventing the theft of certain items. Car theft is a particularly difficult problem, as the standardization of vehicles makes it easily for thieves to work around factory security systems. A suitable solution is desired.

U.S. Pat. No. 5,276,728 to Kenneth Pagliaroli et al. relates to a remotely activated automobile disabling system. The described remotely activated automobile disabling system includes a system for remotely disabling or enabling an automobile having at least one receiver that scans signal codes transmitted in frequencies dedicated to mobile telephone communications, and at least one frequency outside that used in mobile telephone communications. The signal codes received by the receiver are compared to an enabling code and a disabling code stored within a programmable memory. When the owner of an automobile finds the vehicle stolen, the owner dials the telephone number corresponding to the disabling code of the automobile. The dialed number causes a signal code to be transmitted from the mobile telephone transmitted network, wherein the signal code is received by the stolen automobile. If the transmitted signal code matches the programmed disabling code the automobile is disabled.

### SUMMARY OF THE INVENTION

In view of the foregoing disadvantages inherent in the known anti-theft system art, the present disclosure provides a novel vehicle-disabling remote anti-theft system and method. The general purpose of the present disclosure, which will be described subsequently in greater detail, is to provide an efficient and effective vehicle-disabling remote anti-theft system and method.

A vehicle anti-theft system is disclosed herein. The vehicle anti-theft system includes a vehicle control module having an electrical interface, a transceiver, and a GPS receiver, a kill switch, a mobile device with a microphone, a mobile device application, a programmable security passcode, a security camera, at least one impact detection sensor, and a speaker. The vehicle control module communicates with and controls the vehicle via the electrical interface. The transceiver allows the vehicle control module to communicate with the mobile device using a wireless signal, while the GPS receiver receives a signal from a global positioning system satellite in order to determine the vehicle's location at any given time.

The kill switch is integrated into the vehicle in such a way that it communicates with the vehicle control module and may terminate power to the vehicle if so prompted by the vehicle control module. The mobile device application is installed on the mobile device, and provides a user interface enabling a user to control the vehicle control module. The mobile device application may be accessed securely by a user by entering the programmable security code, which may be customized by the user. The security camera is in communication with the vehicle control module and may be used to record video and audio footage. The impact detection sensors may be used to sense an impact and relay a signal to the vehicle control module in the event of an impact. The speaker may be used to transmit and audio message from the vehicle.

According to another embodiment, a method of securing and disabling a vehicle is also disclosed herein. The method of securing and disabling a vehicle includes firstly, providing the described anti-theft system; secondly, accessing the user interface of the mobile device application via the mobile device; thirdly, identifying a location of the vehicle; fourthly, sending a termination signal in order to disable the vehicle; and fifthly, disabling a vehicle by activating the kill switch in response to the termination signal. Optionally, the method may also include receiving an alert notification from the vehicle control module indicating a security risk via the mobile device application.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a vehicle-disabling remote anti-theft system and method, constructed and operative according to the teachings of the present disclosure.

FIG. 1 is a perspective view of the vehicle anti-theft system during an ‘in-use’ condition, according to an embodiment of the disclosure.

FIG. 2 is a perspective view of the vehicle anti-theft system of FIG. 1, according to an embodiment of the present disclosure.

FIG. 3 is a perspective view of the vehicle anti-theft system of FIG. 1, according to an embodiment of the present disclosure.

FIG. 4 is a perspective view of the vehicle anti-theft system of FIG. 1, according to an embodiment of the present disclosure.

FIG. 5 is a flow diagram illustrating a method of use for remotely disabling and securing a vehicle, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an anti-theft system and more particularly to a vehicle-disabling remote anti-theft system and method as used to improve the remote disabling and securing of a so-equipped vehicle.

The vehicle-disabling remote anti-theft system allows the power to a vehicle's engine to be cut remotely by a user. This system may be used to prevent thieves from getting away with a stolen vehicle. The system may be applied to a wide range of vehicle types, including automobiles and motorcycles. The system provides vehicle owners with peace of mind knowing that their vehicle is more likely to be returned to them if stolen.

The system includes a smartphone application installed on a mobile device such as a smartphone that allows a vehicle anti-theft system to be controlled remotely. The mobile application may be used to shut off power to at least one required vehicle operation system, causing the vehicle to stop. The mobile device communicates with a chip/adapter that installs in the vehicle and pairs wirelessly with the cell phone application. Should the vehicle be stolen, a person may access the application via their phone, input a password or code, and choose to disable the vehicle, thereby preventing the vehicle from traveling further, and greatly increasing the likelihood that the vehicle will be recovered by the police.

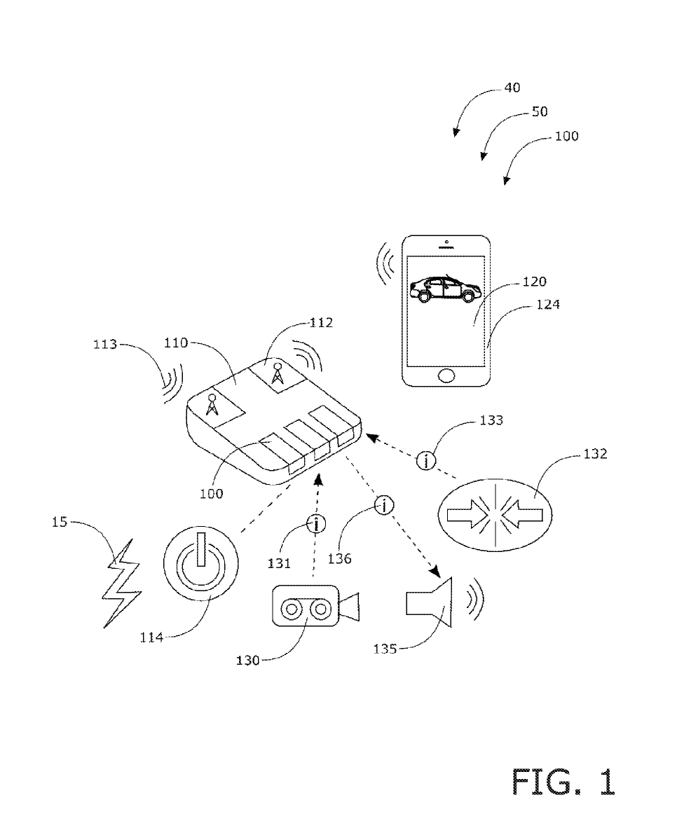

Referring now more specifically to the drawings by numerals of reference, there is shown in FIGS. 1-4, various views of a vehicle anti-theft system 100.

FIG. 1 shows a vehicle anti-theft system 100 during an ‘in-use’ condition 50, according to an embodiment of the present disclosure. Here, the vehicle anti-theft system 100 may be beneficial for use by a user 40 to deter vehicle 10 theft. As illustrated, the vehicle anti-theft system 100 may include vehicle control module 110, kill switch 114, mobile device 120, mobile device application 124, security camera 130, impact detection sensor 132, and speaker 135.

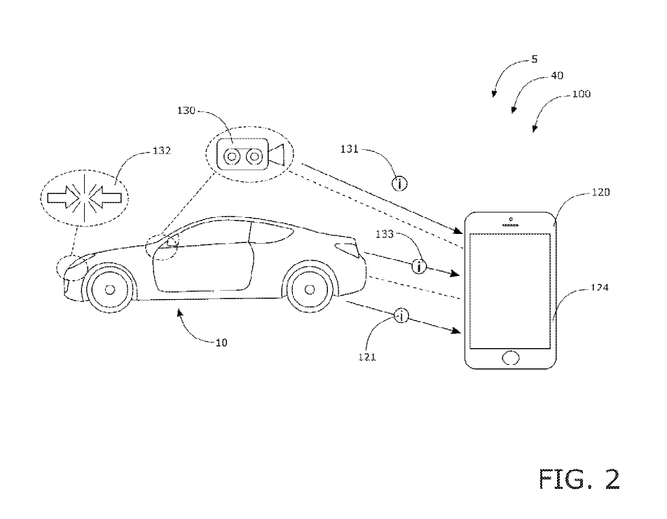

Vehicle control module 110 is configured to track and disable vehicle 10 (shown in FIG. 2), and includes electrical interface 111 for communicating with vehicle 10 (FIG. 2), transceiver 112 for transmitting and receiving a wireless signal, and GPS receiver 113 for tracking location 5 of vehicle 10. Kill switch 114 is in communication with vehicle control module 110 and is configured to terminate power 15 to vehicle 10 such that vehicle 10 becomes inoperable. Mobile device 120 includes microphone 122, and is in wireless communication with transceiver 112 of vehicle control module 110. Mobile device application 124 is configured to be installed on mobile device 120 for providing user interface 126 for enabling user 40 to control vehicle control module 110. Security camera 130 is in communication with vehicle control module 110, and is configured to record video and audio footage 131. Impact detection sensor 132 is in communication with vehicle control module 110, being configured to relay impact signal 133 to vehicle control module 110 in response to impact event 134 (FIG. 2). Speaker 135 is in electrical communication with vehicle control module 110, being configured to transmit audio broadcast 136 generated by user 40. Upon reading this specification, it should be appreciated that, under appropriate circumstances, considering such issues as user preferences, design preference, structural requirements, marketing preferences, cost, available materials, technological advances, etc., other technological arrangements such as, for example, additional vehicle security features, alternative control module constructions, etc., may be sufficient.

According to one embodiment, the vehicle anti-theft system 100 may be arranged as a kit 105. In particular, the vehicle anti-theft system 100 may further include a set of instructions 107. The instructions 107 may detail functional relationships in relation to the structure of the vehicle anti-theft system 100 such that the vehicle anti-theft system 100 can be used, maintained, or the like, in a preferred manner.

FIG. 2 shows the vehicle anti-theft system 100 of FIG. 1, according to an embodiment of the present disclosure. As shown, impact signal 133 is relayed from the impact detection sensor 132, prompting security camera 130 to record video and audio footage 131 following impact event 134. Mobile device application 124 generates notification 121 in response to impact event 134, notification 121 being configured to prompt user 40 to view video and audio footage 131 of impact event 134. Mobile device application 124 is configured to display location 5 of vehicle 10 in real time.

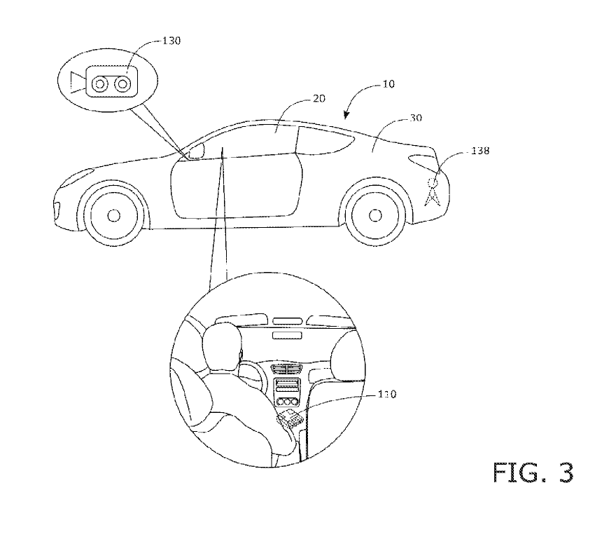

FIG. 3 is a perspective view of the remote vehicle anti-theft system 100 of FIG. 1, according to an embodiment of the present disclosure. Security camera 130 is placed inside of vehicle 10, security camera 130 being positioned to view interior 20 and exterior 30 of vehicle 10. Remote vehicle anti-theft system 100 further includes at least one proximity sensor 138 in communication with vehicle control module 110; at least one proximity sensor 138 being configured to detect unauthorized contact with vehicle 10. Vehicle control module 110 prompts security camera 130 to record video and audio footage 131 when at least one proximity sensor 138 detects unauthorized contact with vehicle 10.

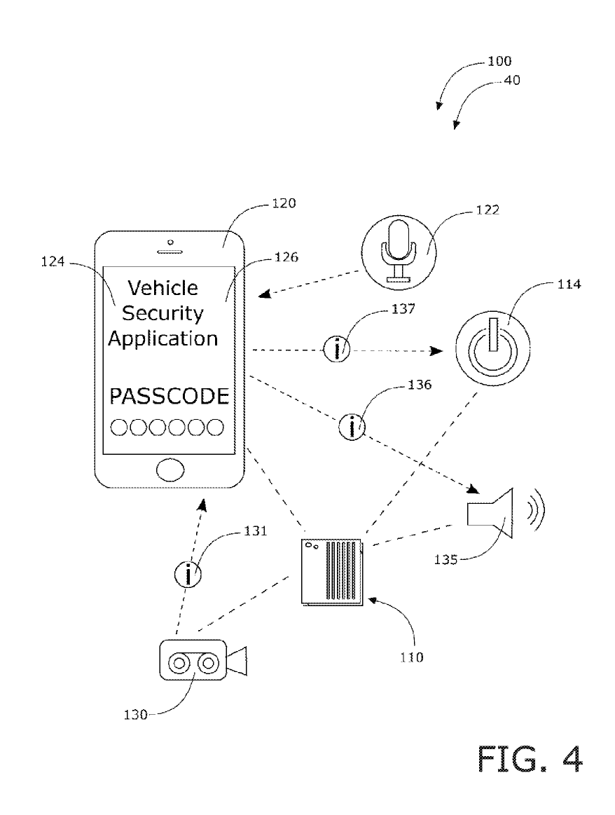

FIG. 4 is a perspective view of the remote vehicle anti-theft system 100 of FIG. 1, according to an embodiment of the present disclosure. Programmable security passcode 128 may be entered by user 40 into user interface 126 in order to access mobile device application 124, thereby enabling control of the remote vehicle anti-theft system 100. Kill switch 114 is configured to receive termination signal 137 received by vehicle control module 110 from mobile device 120, termination signal 137 being generated by user 40 via user interface 126 of mobile device application 124. Mobile device 120 is configured to send audio broadcast 136 to speaker 135, audio broadcast 136 being recorded by microphone 122 of mobile device 120. Video and audio footage 131 recorded by security camera 130 is viewable via mobile device 120 using mobile device application 124, video and audio footage 131 being viewable as a live feed and alternatively as an archived recording. Programmable security passcode 128 is able to be selected by user 40.

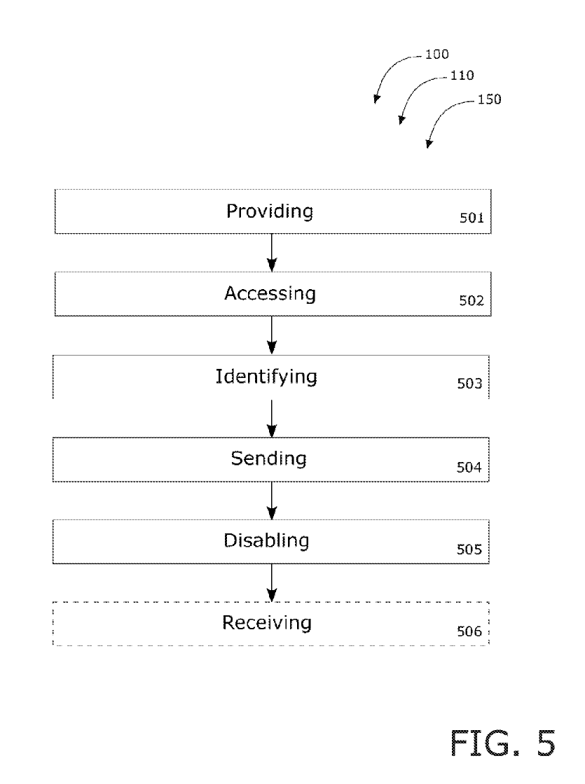

FIG. 5 is a flow diagram illustrating a method 500 for remotely disabling and securing a vehicle 10, according to an embodiment of the present disclosure. In particular, the method 500 for remotely disabling and securing a vehicle 10 may include one or more components or features of the vehicle anti-theft system 100 as described above. As illustrated, the method 500 for disabling a vehicle 10 may include the steps of: step one 501, providing a remote vehicle anti-theft system for securing a vehicle comprising a vehicle control module for tracking and disabling the vehicle including an electrical interface for communicating with the vehicle and a transceiver for transmitting and receiving a wireless signal, a kill switch in communication with the vehicle control module configured to terminate power to the vehicle such that the vehicle becomes inoperable, a mobile device having a microphone in wireless communication with the transceiver of the vehicle control module, a mobile device application configured to be installed on the mobile device for providing a user interface enabling control of the vehicle control module, a programmable security passcode for accessing the mobile device application and enabling control of the remote vehicle anti-theft system configured to be entered into the user interface of the mobile device application, a security camera in communication with the vehicle control module configured to record video and audio footage, at least one impact detection sensor in communication with the vehicle control module configured to relay an impact signal to the vehicle control module upon an impact event, and a speaker in electrical communication with the vehicle control module configured to transmit an audio broadcast generated by a user; step two 502, accessing the user interface of the mobile device application via the mobile device; step three 503, identifying a location of the vehicle; step four 504, sending a termination signal configured to disable the vehicle; step five 505, disabling a vehicle by activating the kill switch in response to the termination signal; and step six 506, receiving an alert notification from the vehicle control module indicating a security risk, wherein the alert notification is generated by the mobile device application.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for remotely disabling and securing a vehicle, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A remote vehicle anti-theft system for securing a vehicle, the system comprising:
a vehicle control module for tracking and disabling the vehicle including
an electrical interface for communicating with the vehicle,
a transceiver for transmitting and receiving a wireless signal; and
a GPS receiver for tracking a location of the vehicle;
a kill switch in communication with the vehicle control module configured to terminate power to the vehicle such that the vehicle becomes inoperable;
a mobile device having a microphone in wireless communication with the transceiver of the vehicle control module;
a mobile device application configured to be installed on the mobile device for providing a user interface enabling control of the vehicle control module;
a programmable security passcode for accessing the mobile device application and enabling control of the remote vehicle anti-theft system configured to be entered into the user interface of the mobile device application;
a security camera in communication with the vehicle control module configured to record video and audio footage;
at least one impact detection sensor in communication with the vehicle control module configured to relay an impact signal to the vehicle control module upon an impact event; and
a speaker in electrical communication with the vehicle control module configured to transmit an audio broadcast generated by a user.

2. The remote vehicle anti-theft system of claim 1, wherein the kill switch is configured to terminate power to the vehicle in response to a termination signal received by the vehicle control module from the mobile device, the termination signal being generated by a user via the user interface of the mobile device application.

3. The remote vehicle anti-theft system of claim 1, wherein the mobile device is configured to send the audio broadcast to the speaker, the audio broadcast being recorded by the microphone of the mobile device.

4. The remote vehicle anti-theft system of claim 1, wherein the impact signal relayed from the at least one impact detection sensor prompts the camera to record video and audio footage following the impact event.

5. The remote vehicle anti-theft system of claim 1, wherein the video and audio footage recorded by the camera may be viewed via the mobile device using the mobile device application, the video and audio footage being viewable as a live feed and alternatively as an archived recording.

6. The remote vehicle anti-theft system of claim 1, wherein the mobile device application generates a notification in response to the impact event, the notification being configured to prompt a user to view video and audio footage of the impact event.

7. The remote vehicle anti-theft system of claim 1, wherein the security camera is placed inside of the vehicle, the security camera being positioned to view the interior and alternatively the exterior of the vehicle.

8. The remote vehicle anti-theft system of claim 1, wherein the remote vehicle anti-theft system further includes at least one proximity sensor in communication with the vehicle control module configured to detect unauthorized contact with the vehicle.

9. The remote vehicle anti-theft system of claim 8, wherein the vehicle control module prompts the security camera to record video and audio footage when the at least one proximity sensor detects unauthorized contact with the vehicle.

10. The remote vehicle anti-theft system of claim 1, wherein the remote vehicle anti-theft system may be retrofitted to security hardware installed in the vehicle, wherein the security hardware is selecting from a group including a car camera, a car speaker, a car impact sensor, and a car proximity sensor.

11. The remote vehicle anti-theft system of claim 1, wherein the mobile device application is configured to display the location of the vehicle in real time.

12. The remote vehicle anti-theft system of claim 1, wherein the electrical interface of the vehicle control module is an OBD-II connector.

13. The remote vehicle anti-theft system of claim 1, wherein the electrical interface of the vehicle control module is a secure digital connector.

14. The remote vehicle anti-theft system of claim 1, wherein the programmable security passcode is able to be selected by the user.

15. The remote vehicle anti-theft system of claim 1, wherein the vehicle is an automobile.

16. The remote vehicle anti-theft system of claim 1, wherein the vehicle is a motorcycle.

17. A vehicle-disabling remote anti-theft system comprising:
a vehicle control module for tracking and disabling the vehicle including
an electrical interface for communicating with the vehicle,
a transceiver for transmitting and receiving a wireless signal; and
a GPS receiver for tracking a location of the vehicle;
a kill switch in communication with the vehicle control module configured to terminate power to the vehicle such that the vehicle becomes inoperable;
a mobile device having a microphone in wireless communication with the transceiver of the vehicle control module;
a mobile device application configured to be installed on the mobile device for providing a user interface enabling control of the vehicle control module;
a programmable security passcode for accessing the mobile device application and enabling control of the remote vehicle anti-theft system configured to be entered into the user interface of the mobile device application;
a security camera in communication with the vehicle control module configured to record video and audio footage;
at least one impact detection sensor in communication with the vehicle control module configured to relay an impact signal to the vehicle control module upon an impact event; and
a speaker in electrical communication with the vehicle control module configured to transmit an audio broadcast generated by a user;
wherein the kill switch is configured to terminate power to the vehicle in response to a termination signal received by the vehicle control module from the mobile device, the termination signal being generated by a user via the user interface of the mobile device application;
wherein the mobile device is configured to send the audio broadcast to the speaker, the audio broadcast being recorded by the microphone of the mobile device;
wherein the impact signal relayed from the at least one impact detection sensor prompts the camera to record video and audio footage following the impact event;
wherein the video and audio footage recorded by the camera may be viewed via the mobile device using the mobile device application, the video and audio footage being viewable as a live feed and alternatively as an archived recording;
wherein the mobile device application generates a notification in response to the impact event, the notification being configured to prompt a user to view video and audio footage of the impact event;
wherein the security camera is placed inside of the vehicle, the security camera being positioned to view the interior and alternatively the exterior of the vehicle;
wherein the remote vehicle anti-theft system further includes at least one proximity sensor in communication with the vehicle control module configured to detect unauthorized contact with the vehicle;
wherein the vehicle control module prompts the security camera to record video and audio footage when the at least one proximity sensor detects unauthorized contact with the vehicle;
wherein the mobile device application is configured to display the location of the vehicle in real time; and
wherein the programmable security passcode is able to be selected by the user.

18. The remote vehicle anti-theft system of claim 17, further comprising a set of instructions; and
wherein the remote vehicle anti-theft system is arranged as a kit.

19. A method of disabling a vehicle, the method comprising the steps of:
providing a remote vehicle anti-theft system for securing a vehicle comprising a vehicle control module for tracking and disabling the vehicle including an electrical interface for communicating with the vehicle and a transceiver for transmitting and receiving a wireless signal, a kill switch in communication with the vehicle control module configured to terminate power to the vehicle such that the vehicle becomes inoperable, a mobile device having a microphone in wireless communication with the transceiver of the vehicle control module, a mobile device application configured to be installed on the mobile device for providing a user interface enabling control of the vehicle control module, a programmable security passcode for accessing the mobile device application and enabling control of the remote vehicle anti-theft system configured to be entered into the user interface of the mobile device application, a security camera in communication with the vehicle control module configured to record video and audio footage, at least one impact detection sensor in communication with the vehicle control module configured to relay an impact signal to the vehicle control module upon an impact event, and a speaker in electrical communication with the vehicle control module configured to transmit an audio broadcast generated by a user;
accessing the user interface of the mobile device application via the mobile device;
identifying a location of the vehicle;
sending a termination signal configured to disable the vehicle;
disabling a vehicle by activating the kill switch in response to the termination signal.

20. The method of claim 19, further comprising the steps of
receiving an alert notification from the vehicle control module indicating a security risk, wherein the alert notification is generated by the mobile device application.
